(19) United States
(12) Patent Application Publication
(10) Pub. No.: US 2019/0152100 A1
(43) Pub. Date: May 23, 2019

(54) METHOD AND DEVICE FOR PRODUCING MOULDED PARTS

(71) Applicant: FRIMO GROUP GMBH, Lotte (DE)

(72) Inventors: Thomas Rübsam, Lotte (DE); Kamilo Kawala, Lotte (DE)

(21) Appl. No.: 15/506,861

(22) PCT Filed: Aug. 27, 2015
(86) PCT No.: PCT/EP2015/069634

§ 371 Date: Feb. 27, 2017

(30) Foreign Application Priority Data
Aug. 28, 2014 (DE) 102014217173.3

(51) Int. Cl. B29C 45/14

(52) U.S. Cl. CPC B29C 45/14221; B29C 45/14262; B29L 2031/3041; B29C 2045/14188; B29C 2045/1427; B29C 45/14786

(57) ABSTRACT

The present invention relates to a method and a device for producing moulded parts. Moulded parts of this type are used predominantly in automotive construction, for example as interior trim parts. The method and device according to the invention are intended to facilitate the reduction of sizing inaccuracies during high productivity and the flexible design of the cut region of the moulded part that is to be formed.

### TECHNICAL FIELD

The present invention relates to a method and a device for producing molded parts. Such molded parts are preferably used in automotive construction, for example as interior trim parts.

### PRIOR ART

Devices for producing molded parts are known in the prior art. The known devices comprise a tool having a bottom mold and a top mold, a cutting edge being provided on the top mold.

In order to produce a molded part, a material blank is inserted into an open cavity of the tool. By closing the tool, the material blank is formed and an edge portion of the material blank is separated off by the cutting edge.

However, because the material blank is formed along a comparatively long cut region which extends around the entire material blank, the material blank retracts towards the center of the tool. Accordingly, the aim in the prior art is to make the cutting edge as small as possible in order to prevent wide retraction of the material blank. Furthermore, only a small overrun cut is chosen, so that the outer edge is cut when forming has already for the most part taken place. In this state, the material blank is held in such a manner that slipping in the region of the cutting edge is largely avoided.

### DESCRIPTION OF THE INVENTION

Accordingly, the object of the invention is to provide a method and a device for producing molded parts which make it possible to reduce dimensional inaccuracies while achieving high productivity and a flexible design of the cut region of the molded part that is to be formed.

According to the invention, the object is achieved by a method and a device for producing molded parts, in particular decorative parts and/or trim parts for a motor vehicle interior, having the features of the independent patent claims. Further preferred embodiments of the invention are described in the dependent claims.

The method according to the invention for producing molded parts, in particular decorative parts and/or trim parts for a motor vehicle interior, comprises the following steps: inserting and positioning a material blank in an open cavity of a tool having a bottom mold and a top mold, at least one of which is displaceable relative to the other; closing the cavity and forming the material blank by moving the bottom mold and the top mold towards one another; separating off a region of the material blank while the cavity is being closed; forming the material blank by moving the bottom mold and the top mold towards one another and completing closing of the cavity; and molding onto the cut edge by means of injection molding.

A material blank is inserted into the bottom mold. The material blank is thereby preferably heated and already has the required wall thickness of the molded part that is to be formed, optionally with an additional allowance of approximately from 0.2 to 0.3 mm, in order further to generate pressure in the tool. The cavity of the tool is then closed and the material blank is thereby already partially formed.

Before the cavity is closed completely, and thus forming of the material blank is also complete, a region of the material blank (cut region) is separated off. A separating device for separating off the material blank is preferably arranged on the top mold. The thickness of cut for producing the cut region is, for example, adjustable or preset.

Because the material blank retracts towards the center of the tool owing to the forming of the region to be cut, a gap forms between an overrun edge on the tool and a recess end of the tool. The overrun edge is understood as being an edge of the tool, preferably an edge arranged on the top mold of the tool or on the separating device, which overruns a trimming edge of the other mold (here the bottom mold) when the cavity is closed.

When a region of the material blank is separated off, this cutting operation can take place both in the edge region or also in an inner region.

In a preferred embodiment of the invention, the closing operation is carried out without an intermediate stop, although such an intermediate stop is likewise possible.

Furthermore, the term “recess” is used as a synonym for “cavity”, the “recess end” being a region of the recess in the vicinity of the trimming edge.

[symbol]

The region between the trimming edge and the recess end is then overmolded in the same tool, that is to say the cut region, for example an edge region, of the material blank located in that region is molded onto in a further processing step using an injection molding material.

There come into consideration as the injection molding material all thermoplastic and thermosetting plastics materials which can be processed by the injection molding process. In a particularly preferred embodiment, PP is used as the injection molding material. The use of PU is also possible. Accompanying materials, such as, for example, glass fibers, talcum, gases for foaming, etc., can also be processed concomitantly. As a result of the integrated injection molding step, the end edge of the material blank is injection molded “clean”. The desired end edge of the component is thereby obtained. Moreover, the trim quality of the cut edge, which deteriorates over time, can be compensated for. Any dimensional inaccuracies owing to unclean trimming and burr formation can accordingly be compensated for by overmolding or molding onto the cut edge of the material blank. A post-processing step which would otherwise be necessary can thereby be omitted, and the outlay in terms of labor and the manufacturing costs can be reduced. Accordingly, by combining the operations of forming material blanks, trimming and molding-on (injection molding) in one tool, that is to say in one shot in the same place, particularly efficient and productive processing is possible.

Post-processing of the molded parts after they have been removed from the tool is not necessary, and narrower dimensional tolerances can be maintained than in the case of a conventional tool. Furthermore, the method according to the invention offers greater flexibility in the design of the edge region of the molded part that is to be formed, since the method offers the possibility of molding onto an end edge and thereby also producing different geometries. As a result, the wall thickness of the molded part in the edge region, for example, can be adjusted and special shapes, such as, for example, grooves, lips, wedge or semi-circular shapes, can be molded on. It is accordingly possible to achieve not only clean, that is to say, for example, burr-free, end edges, but also different end edges with variably changeable geometries. The possibility of varying the design of the end edge of the molded part that is to be formed additionally also achieves advantages for further processing. For example, the variable design of the end edge also permits an improved possibility for adhesive-free edge folding.

According to a preferred embodiment, separation of the edge region of the material blank, in dependence on a material retraction of the material blank that is to be achieved, is carried out before the cavity of the tool is closed completely. In this respect, attempts have hitherto always been made to separate off the edge region with maximum possible dimensional accuracy in order to avoid any post-processing of the molded part that is produced. However, because a certain amount of material retraction is unavoidable owing to the forming of the edge region, the material blanks have hitherto been trimmed only slightly in advance, that is to say only shortly before the tool cavity is closed completely. The aim here was to keep the material retraction as small as possible in order to achieve the desired dimensional accuracy.

However, the inventors of the present application have taken advantage of the material retraction which hitherto was regarded as a disadvantage. Therefore, according to the invention, in contrast to the prior art, separation of the end region of the material blank is performed further in advance, that is to say at a greater interval before final closing of the tool cavity than in the prior art.

That is to say, a material retraction, which hitherto was always to be prevented, is purposively brought about according to the invention. By trimming the material blank further in advance, the effect of the free edge for injection molding is created. The advance that is established in a particular case hereby determines the amount of the material blank that retracts, or the amount of material retraction. In other words, the thickness of the finished injection-molded edge, or the size of the injection molding region, depends on how far in advance the material blank has been cut, and on the amount by which it has further been formed. Trimming further in advance accordingly leads to greater material retraction and thus also to a larger peripheral gap between the trimming edge on the tool and the recess end of the tool. In this case, edges with a greater thickness can be molded onto the material blank. Conversely, trimming less far in advance leads to less material retraction and thus also to a smaller peripheral gap between the trimming edge on the tool and the recess end of the tool. In this case, edges with a smaller thickness can be injection molded onto the material blank. The desired advance can be permanently built into the tool or can also be variably adjusted by the separating device, such as, for example, a cutting plate.

According to a preferred embodiment, separation of the region of the material blank that is to be cut and complete closing of the cavity of the tool, and thus final pressing of the material blank, are performed in one stroke. That is to say, the separating operation and final pressing are performed in a continuous stroke without further relative movements. The tool is thereby closed without stopping, although it is slowed down. Control of the process of producing the molded part is thereby simplified.

According to a preferred embodiment of the present invention, the material blank comprises a semi-finished fiber product. When the material blank is formed of a semi-finished fiber product, the fibers of the material blank retract towards the center of the tool owing to the forming of the edge region during production of the molded part. Such retraction of the fibers occurs in particular when the fibers are trimmed far in advance of the forming stroke. That is to say, in this case edges having a greater thickness can be molded onto the material blank because, owing to the greater fiber retraction, a larger injection molding region is formed between the trimming edge and the recess end. As already mentioned above, the thickness of the finished injection-molded edge, or the size of the injection molding region, depends on how far in advance the fibers have been cut and on the amount by which the fibers have further been formed.

The material blank, or the semi-finished fiber product, is preferably pre-calibrated, that is to say the semi-finished fiber product has already been brought to an exact dimension beforehand. During pre-calibration, the material blank, or the semi-finished fiber product, is preferably additionally exposed to a heat input, which serves to activate the semi-finished fiber product for the subsequent processing process.

According to a preferred embodiment of the present invention, the semi-finished fiber product is formed from a fiber composite. The semi-finished fiber product is particularly preferably formed from a fiber-plastics material composite, that is to say thermoplastically bonded fibers. A natural fiber/polypropylene mixture (NFPP) is particularly preferred. However, any fiber materials having a matrix come into consideration. Further materials which can be used as the material blank in the method according to the invention include, for example, CRP, GRP, polyamide-matrix composite materials or organic sheets. The use of organic sheets has the advantage that they can be inserted in a heated state into the corresponding mold of the tool, whereby they merely have to be reactivated. On the other hand, when processing NFPP material blanks, for example, a pre-calibration is generally also required, that is to say they are brought to an exact dimension as well as exposed to a heat input. The injection molding material used to form the edge preferably comprises the matrix material of the material blank to be processed. Owing to their low density and high strength, fiber composites are particularly suitable for decorative parts and/or trim parts for a motor vehicle interior.

According to a particular embodiment of the present invention, the cut edge is overmolded with rear ribs or direct gating. The provision of ribs is frequently necessary on door panels, for example, where reinforcing ribs are provided on convex radii. These reinforcing ribs often extend as far as the trimmed end edge of the material blank. In this case, the reinforcing ribs serve as suppliers of injection molding material to the edge to be overmolded and are connected to the overmolded edge. Such reinforcing ribs extend not in the alignment direction of the end edge but preferably at an angle of 90° to the alignment direction of the end edge. If ribs are to be formed on the molded part, the material retraction is preferably set at 2 to 3 mm so that a sufficiently large injection molding cavity with the possibility of reproduction is formed.

The molded parts obtained by the method described above can subsequently also be laminated. Lamination is preferably carried out without adhesive, as is described in EP 2 457 706 A of the same applicant. Lamination can preferably take place as a combined process, that is to say forming, laminating and molding-on in one tool. In this case, a decorative material would preferably be supplied to the tool, which would then be laminated and adhesively bonded (and formed) at the same time.

A device for producing molded parts, in particular decorative parts and/or trim parts for a motor vehicle interior, has the features of independent claim 7.

The same advantages are achieved by the device according to the invention as are achieved by the method according to the invention described above.

The device comprises in particular an injection molding cavity or a molding-on channel, which is provided in the region of the cut edge produced on the material blank, that is to say spaces are left in the tool for the injection supply. The injection molding cavity is so provided that the region of the material blank to be cut, which is located between the trimming edge and the recess end, can be overmolded. As a result, it is possible to achieve a “clean” end edge of the molded part, so that a trim quality impaired by the wear of the separating device is compensated for. Furthermore, particularly efficient and productive processing is possible because of the combined processing of material blanks, that is to say the combination of forming, trimming and molding-on in a tool, that is possible in the device.

As a result, post-processing of the molded parts after they have been removed from the tool is not necessary, and narrower dimensional tolerances can be maintained than in the case of a conventional tool. It is also not necessary to provide any further tools or devices, and the number of process steps is reduced.

The device according to the invention further permits greater flexibility in the design of the edge region of the molded part that is to be formed, since the end edge is molded onto the material blank and different geometries of the end edge can accordingly be produced. The shape of the injection molding cavity accordingly decides the later shape of the molded-on edge. The injection molding cavity is in the form of an injection molding tool having a recess, an ejector plate/slider plate, a heating channel system with needle valve nozzles and a base plate. Depending on the machine, the sprue bushing can be guided out either downwards or to the side. The recess includes all geometries in order to press the material blank, or the mat, flat, and ribs/runners and/or superstructural parts that are relevant for fixing, where the injection molding material can be distributed. It is not absolutely essential, over the already described connection of the ribs to the end edge, to place the sprue points at the end edge.

The device according to the invention can also have cutting plates, for example, as the separating device. This is particularly advantageous in the production of interior trim parts for automotive construction. For example, the outside geometry in the case of door panels is on one plane in large parts. It is here possible to provide a workable surface, where “2D cutting plates” or also “3D cutting plates” can be screwed on. These cutting plates can additionally have different thicknesses. The cutting plates would preferably be so fixed that they constitute an extension of the cut edge. In the case of an enlargement of the thickness, the tool accordingly cuts the material blank beforehand. Owing to the still open forming stroke during separation, nothing more slides into the tool, but the gap for the injection molding material becomes larger.

According to a preferred embodiment of the present invention, the bottom mold and/or the top mold, that is to say the respective mold recesses, can be temperature-controlled. Preferably both the bottom mold and the top mold can be temperature-controlled, it also being possible for the two molds to be temperature-controlled independently of one another. In a particularly preferred embodiment, the top mold and the bottom mold are each divided into a plurality of zones and temperature-controlled separately. In addition to temperature control of the mold recesses, temperature control of further possible components of the tool, such as, for example, an ejector plate and a heating channel plate, is also taken into consideration.

According to a further development of the invention, a clamping frame for positioning the material blank is provided. For producing a molded part, a material blank is inserted into the open tool cavity, so that the material blank rests on the bottom mold and the clamping frame. If the device—and thus the tool cavity—is closed, the material blank is formed by the top mold and the bottom mold and the edge portion of the material blank is separated off by the separating device. The clamping frame is particularly advantageously in the form of a combined clamping and ejector frame. This combined clamping and ejector frame serves during removal of the molded part from the mold in particular as an ejector frame for the waste region and/or of the finished part.

[symbol]

### BRIEF DESCRIPTION OF THE DRAWINGS

The invention is described in greater detail below by means of exemplary embodiments with reference to the accompanying figures.

FIG. 1 is a schematic cross-sectional side view of a first embodiment of a device for producing molded parts, wherein a tool is shown in an open state.

FIG. 1a is a detail view of FIG. 1.

FIG. 2 is a schematic cross-sectional side view of the device according to the first embodiment, wherein the tool is shown in an almost closed state.

FIG. 2a is a detail view of FIG. 2.

FIG. 3 is a schematic cross-sectional side view of the device according to the invention according to the first embodiment, wherein the tool is shown in a completely closed state.

FIG. 3a is a detail view of FIG. 3.

FIG. 4 is a schematic cross-sectional side view of a second embodiment of a device for producing molded parts, wherein a tool is shown in an open state.

FIG. 4a is a detail view of FIG. 4.

FIG. 5 is a schematic cross-sectional side view of the device according to the first embodiment, wherein the tool is shown in an almost closed state.

FIG. 5a is a detail view of FIG. 5.

FIG. 6 is a schematic cross-sectional side view of the device according to the first embodiment, wherein the tool is shown in a completely closed state.

FIG. 6a is a detail view of FIG. 6.

FIG. 7 is a cross-sectional view of the device according to the first or second embodiment with a gate and ejector system.

FIG. 8 is a top view of a bottom mold of the device according to the invention for producing molded parts.

### DETAILED DESCRIPTION OF THE PREFERRED EMBODIMENT

Preferred embodiments of the present invention are described hereinbelow with reference to the accompanying drawings. Individual features of the embodiments and modifications can each be combined with other embodiments in order to form further variants of the invention.

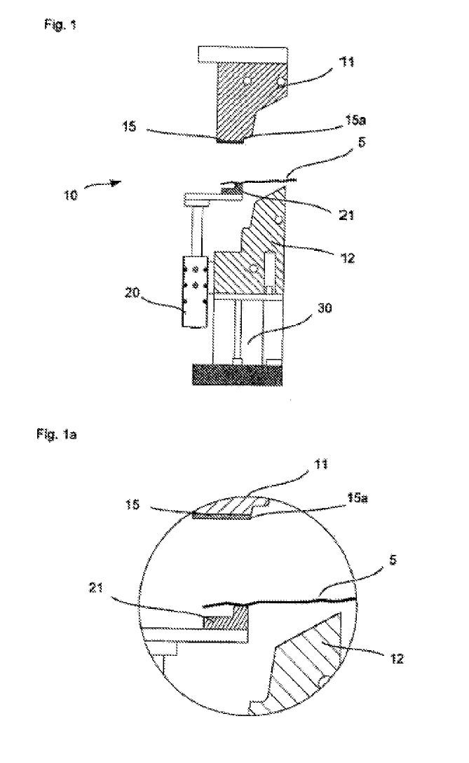

FIG. 1 is a schematic cross-sectional side view of the device 10 according to the invention for producing molded parts. The device 10 comprises a bottom mold or bottom tool 12 and a top mold or top tool 11 for forming a material blank 5.

In the case of the device 10 shown in FIG. 1, the device is shown in an open state. The material blank 5 is preferably a semi-finished fiber product, such as, for example, a pre-calibrated NFPP mat. In the embodiment shown, the top mold 11 is displaceable relative to the bottom mold 12. The device 10 further comprises a frame or a substructure 30 as well as a positioning device or displacing unit 20. A clamping frame 21 for positioning the material blank 5 is arranged on the positioning device 20 and is in the form of a combined clamping and ejector frame 21.

As can be seen in the detail in FIG. 1a, the material blank 5 is inserted into the bottom mold 12 and arranged on the clamping frame 21. The device 10 further comprises a separating device 15 arranged on the top mold 11 for separating off an edge region of the material blank 5.

The separating device 15 is in the form of a cutting tool, such as, for example, a cutting ring or a cutting plate (shown here), and has an overrun edge 15a. Since the cutting plate 15 in the present embodiment is removably fixed to the upper tool, the thicknesses of the cutting plate are variably adjustable, the time at which the cutting plate 15 engages with the region of the material blank 5 that is to be cut (here the edge region) depending on the thickness of the cutting plate 15. That is to say, when the cutting plate 15 has a greater thickness, the cutting plate (separating device) 15 cuts the material blank 5 at an earlier point in time during the operation of closing the upper and bottom mold 11, 12 than when the cutting plate 15 has a smaller thickness.

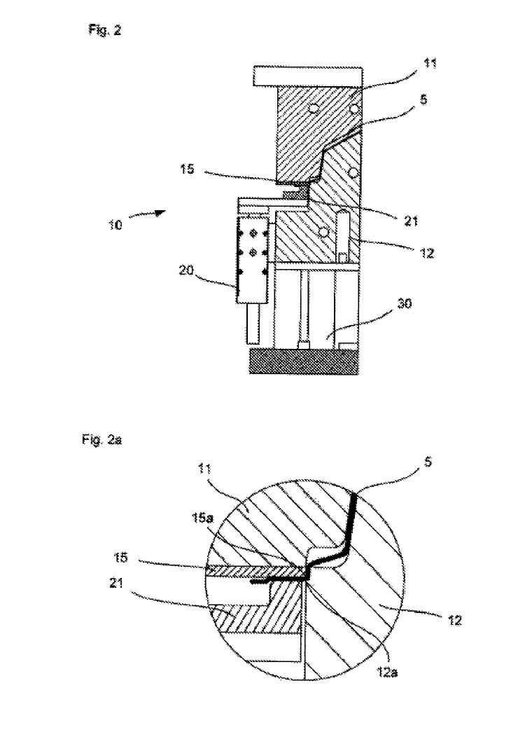

After the material blank 5 has been inserted into the bottom mold 12, the top mold 11 is moved towards the bottom mold 12 and the cavity of the tool 10 is thereby partially closed (see FIG. 2). The closing operation is carried out continuously according to the present embodiment but, from a technical point of view, it can also be carried out stepwise.

The material blank 5 is already partially formed during the closing operation. Before the cavity is completely closed, and thus also before forming of the material blank is complete, an edge region of the material blank 5 is separated off.

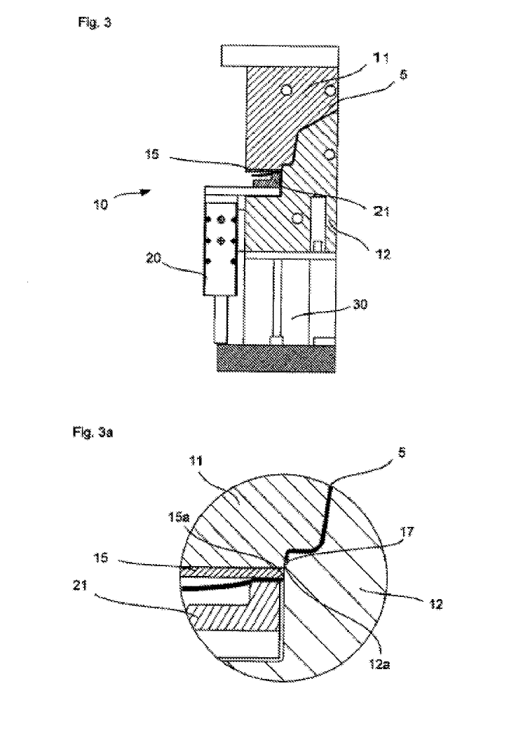

In FIG. 2a, the device (tool) 10 is shown in an almost closed state. It can clearly be seen here that the cavity of the device 10 is not yet completely closed, that is to say the top mold 11 has not yet been moved completely down onto the bottom mold 12. It is likewise apparent from FIG. 2a that the material blank 5 is separated at an overrun edge 15a when the device 10 is closed further and the overrun edge 15a runs over a trimming edge 12a of the lower tool 12. The cutting operation is apparent from considering FIG. 2/2a and the following FIG. 3/3a together.

In FIG. 3, the device 10 is shown in a completely closed state. In this state, a region of the material blank 5 that is to be cut has already been separated off. As can be seen in FIG. 3a in particular, the material blank 5 has retracted towards the center of the tool. As a result of the material retraction, an additional space forms between the edge of the material blank 5 and the bottom mold 12, so that it is possible to overmold the entire edge region of the material blank 5 around the cut edge 5a in an injection molding cavity or injection molding recess 17 arranged in the bottom mold.

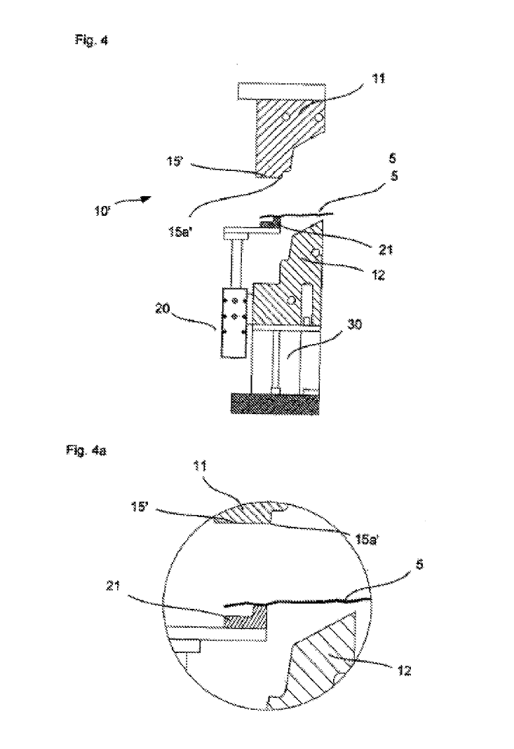

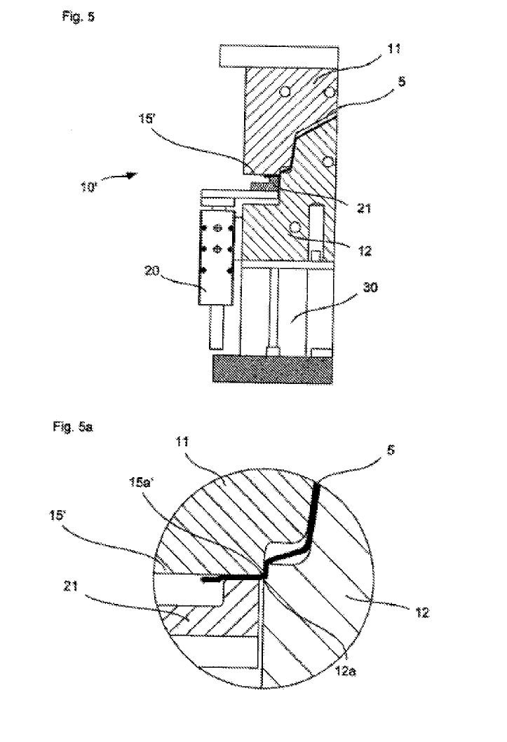

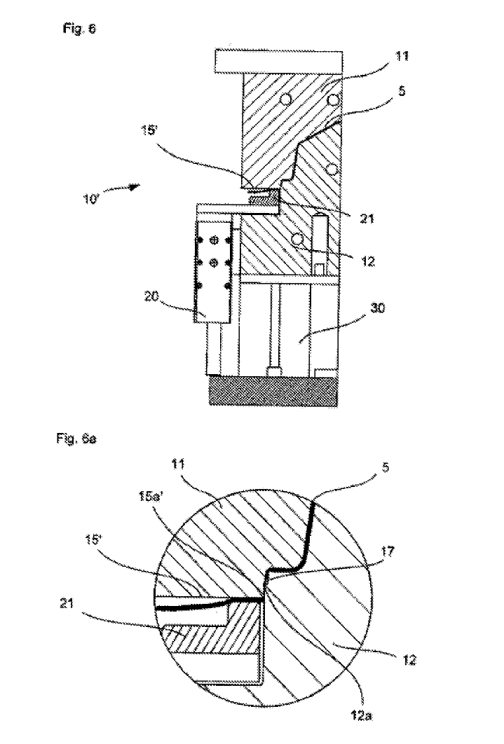

A second embodiment of the present invention is shown in FIGS. 4, 4a, 5, 5a, 6 and 6a. Corresponding or similar components as in the first embodiment are identified by the same reference numerals, and reference is made to the above comments for a more detailed explanation of these components.

The second embodiment differs from the first embodiment substantially in that, instead of a cutting plate 15, a corresponding region of the top mold 11 is in the form of the separating device 15′ so that an overrun edge 15a′ is formed as in the cutting plate of the first embodiment. In this case, the assembly outlay in producing the device was reduced because the separate separating device shown in the first embodiment is already integrated into the top mold 11. The further procedure when using the device 10′ of the second embodiment corresponds to that of the first embodiment.

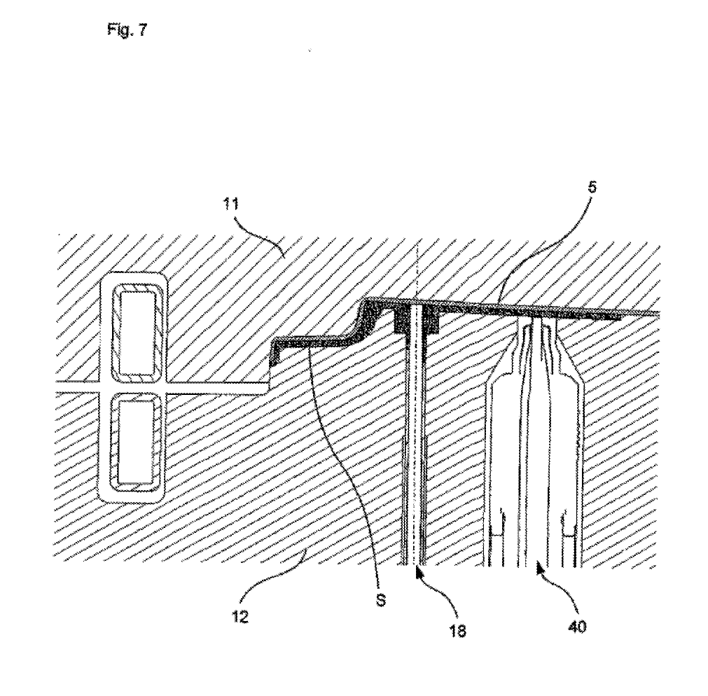

FIG. 7 is a sectional view of the device 10/10′ according to the first or second embodiment. In the state shown, the tool is closed. Furthermore, an injection molding material S has already been injected behind the material blank 5 via the sprue runner 18. In a subsequent method step, the component so produced is pushed out of the bottom mold 12 by means of one or more ejector pins 40, so that it can be removed.

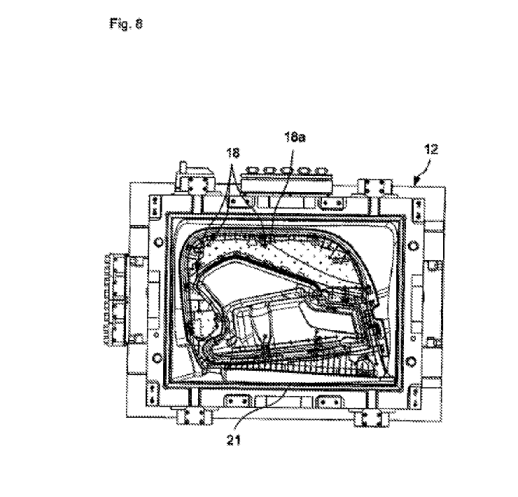

Finally, FIG. 8 shows a schematic top view of the bottom mold 12 of the device 10 according to the invention for producing molded parts. As can be seen in FIG. 8, the clamping frame 21 is arranged on the bottom mold 12. The size of the material blank 5 to be processed preferably corresponds approximately to the size of the clamping frame 21.

A plurality of sprue runners 18 are shown in the bottom mold 12, only some of these sprue runners being provided with reference numerals. A plurality of sprue runner ribs 18a are in communication with the sprue runners 18, which sprue runner ribs extend towards the trimming edge 12a, which comes into engagement with the overrun edge 15a, 15a′, so that the injection molding material is fed to the injection molding cavity 17 (see e.g. FIG. 3).

In order to produce a molded part, a material blank 5 is inserted into the bottom mold 12. The cavity of the device 10 is then closed and the material blank 5 is thereby already partially formed. Before the cavity is closed completely, and thus also before forming of the material blank 5 is complete, a region (edge region) of the material blank 5 is separated off by the separating device 15, 15′. Separation of the (edge) region of the material blank 5 is performed, in dependence on the material retraction of the material blank 5 that is to be achieved, before the cavity of the device 10 is closed completely.

Because the material blank 5 retracts towards the center of the tool as a result of the forming of the (edge) region, a peripheral gap forms between the trimming edge 12a and a recess end of the bottom mold 12. The region of the cut-off region of the material blank 5a is then overmolded with an injection molding material in the injection molding cavity 17.

### LIST OF REFERENCE NUMERALS

10, 10′ Device for producing molded parts (tool)

5 Material blank

11 Top mold

12 Bottom mold

12a Trimming edge

15, 15′ Separating device

15a, 15a′ Overrun edge

17 Injection molding cavity

18 Sprue runner for injection molding

18a Sprue runner ribs

20 Positioning device

21 Clamping and ejector device

30 Frame

40 Ejector pin

1. A method for producing molded parts, in particular decorative parts and/or trim parts for a motor vehicle interior, comprising:
inserting and positioning a material blank in an open cavity of a device having a bottom mold and a top mold, at least one of which is displaceable relative to the other;
closing the cavity and forming the material blank by relative movement of the bottom mold and the top mold towards one another;
separating off a region of the material blank while the cavity is being closed;
followed by further forming of the material blank by moving the bottom mold and the top mold towards one another and completing closing of the cavity; and
molding onto a region adjacent to the cut region of the material blank by means of injection molding.

2. The method according to claim 1, wherein the separation of the material blank is performed before the cavity is closed completely, in dependence on a material retraction of the material blank that is to be achieved.

3. The method according to claim 1, wherein the separation of the region of the material blank and complete closing of the cavity of the device are performed in one stroke.

4. The method according to claim 1, wherein the material blank comprises a semi-finished fiber product.

5. The method according to claim 4, wherein the semi-finished fiber product is formed from a fiber composite, in particular a fiber/plastics material composite, for example a natural fiber/polypropylene mixture.

6. The method according to claim 1, wherein the cut edge and the rear ribs, dome and retainer are injection molded.

7. A device for producing molded parts, in particular decorative parts and/or trim parts for a motor vehicle interior, comprising:
a bottom mold and a top mold for forming a material blank, at least one of which is displaceable relative to the other;
a separating device preferably arranged on the top mold for separating the material blank; and
wherein the separating device is so configured that, after the top mold and the bottom mold have been closed, an injection molding cavity is formed between the top mold and the bottom mold and the material blank.

8. The device according to claim 7, wherein the bottom mold and/or the top mold can be temperature-controlled.

9. The device according to claims 7, further comprising a clamping frame for positioning the material blank.

10. The device according to claim 9, wherein the clamping frame is in the form of a combined clamping and ejector frame.

11. The device according to claim 7, wherein the material blank comprises a semi-finished fiber product.

12. The device according to claim 11, wherein the semi-finished fiber product is formed from a fiber composite, in particular a fiber/plastics material composite, for example a natural fiber/polypropylene mixture.

13. The device according to claim 7, wherein the separating device for separating the material blank comprises a cutting plate or is formed integrally on the top mold.
